(19) United States
(12) Patent Application Publication
(10) Pub. No.: US 2019/0080009 A1
(43) Pub. Date: Mar. 14, 2019

(54) CALCULATION OF TUNING PARAMETERS FOR RANKING ITEMS IN A USER FEED

(71) Applicant: LinkedIn Corporation, Sunnyvale, CA (US)

(72) Inventors: Kinjal Basu, Stanford, CA (US); Souvik Ghosh, San Jose, CA (US); Ying Xuan, Sunnyvale, CA (US); Liang Zhang, Fremont, CA (US); Deepak Agarwal, Sunnyvale, CA (US); Yang Yang, Fremont, CA (US)

(21) Appl. No.: 15/700,652

(22) Filed: Sep. 11, 2017

(51) Int. Cl. G06F 17/30; G06F 17/11; G06F 7/544

(52) U.S. Cl. CPC G06F 17/30867; G06F 7/544; G06F 17/11; G06F 17/3053

(57) ABSTRACT

Methods, systems, and computer programs are presented for identifying tuning parameters for mixing items in different categories for a user feed. One method includes maximizing utilities when presenting feeds to social network users, each utility having a weight for mixing items. The method further includes identifying a utilities maximization goal such that a first utility is maximized while other utilities are above a threshold, and initializing a counter. A loop, repeated until convergence, includes generating sample weights; performing an experiment with the sample weights for i users and j feed sessions to determine utility action indicators; for each utility, estimating a posterior distribution of an underlying hyperfunction and drawing samples; for each drawn sample, calculating a utility function and the weight that maximizes the utility function; generating an empirical distribution based on the sample weights; and incrementing the counter. The identified weights are utilized for creating the feeds.

### TECHNICAL FIELD

The subject matter disclosed herein generally relates to methods, systems, and programs for selecting items for a user feed, and more particularly, methods, systems, and computer programs for selecting items for a user feed in a social network while maximizing the utility for different item categories.

### BACKGROUND

Many relevance-driven products and services use statistical models to predict quantities, such as the probability that a member of a social network interacts with an item shown on the user feed of the member and the utility that connections of the member get by the member interacting with that item. Even though the models to predict such quantities are trained rigorously using training data collected from member activities, the final ranking of items often depends on a combination of multiple predicted quantities.

The user feed may contain items from different categories, e.g., job postings, user postings, suggestions for new connections, sponsored posts, etc. Creating the feed means ranking the items from the different categories, merging the items from the different categories, and creating the user feed, which presents the items in sequential order.

The process of ranking items and categories is often very complex, as different goals are desired, such as optimizing user experience and generating revenue from the different categories. This process is often tedious and requires a great deal of experimentation.

### BRIEF DESCRIPTION OF THE DRAWINGS

Various ones of the appended drawings merely illustrate example embodiments of the present disclosure and cannot be considered as limiting its scope.

FIG. 1 is a block diagram illustrating a networked system, according to some example embodiments, including a social networking server.

FIG. 2 is a screenshot of a user feed that includes items in different categories, according to some example embodiments.

FIG. 3 illustrates a process for creating the user feed, according to some example embodiments.

FIG. 4 illustrates a problem definition for selecting filtering parameters, according to some example embodiments.

FIG. 5 illustrates a multi-armed bandit problem.

FIG. 6 is a flowchart of a method for obtaining tuning parameters, according to some example embodiments.

FIG. 7A shows a distribution of functions for selection, according to some example embodiments.

FIG. 7B shows the distributions of functions before and after convergence, according to some example embodiments.

FIG. 8 is a flowchart of a method for estimating a posterior distribution, according to some example embodiments.

FIG. 9 illustrates a social networking server for implementing example embodiments.

FIG. 10 is a chart illustrating the convergence of the probability that a function ƒ/(x) is maximized for a given x, according to some example embodiments.

FIG. 11 is a block diagram illustrating a representative software architecture, which may be used in conjunction with various hardware architectures herein described.

FIG. 12 is a block diagram illustrating components of a machine, according to some example embodiments, able to read instructions from a machine-readable medium (e.g., a machine-readable storage medium) and perform any one or more of the methodologies discussed herein.

### DETAILED DESCRIPTION

Example methods, systems, and computer programs are directed to identifying tuning parameters for mixing items in different categories to create a user feed, according to some example embodiments. Examples merely typify possible variations. Unless explicitly stated otherwise, components and functions are optional and may be combined or subdivided, and operations may vary in sequence or be combined or subdivided. In the following description, for purposes of explanation, numerous specific details are set forth to provide a thorough understanding of example embodiments. It will be evident to one skilled in the art, however, that the present subject matter may be practiced without these specific details.

Creating a user feed in a social network involves satisfying multiple requirements, which often collide with each other, so a difficult tuning process has to be performed in order to meet these requirements. For example, a jobs function may want to find a balance between applications to basic jobs and premium jobs, an engagement function may want to increase the number of interactions of the user with the user feed, a connections function may want to increase the presentation of possible new connections to the user, etc.

In some implementations, the approach used for balancing multiple objectives is to rank items using weighted linear combinations of the predicted objective utility. This means that the ranking of an item within a category is weighted by a factor associated with the category. Thus, a good feed will need to utilize weights that enable all goals to be accomplished.

Finding the weights, also referred to herein as tuning parameters, of the linear combination is sometimes challenging because of the conflicting goals. Multiple experiments, with various values of the tuning parameters, must be performed, each experiment sometimes lasting days or weeks. This is a manual and time-consuming process, and a relevance engineer needs to repeat the manual process of tuning the parameters every time there is a launch of a new model or a change in the environment.

Embodiments present ways to automate the process of finding the values of the tuning parameters that meet the constraints on multiple objectives in a relevance problem. A selected utility is maximized. While minimum utility values for other categories are met. Embodiments provide a fast, scalable solution to the problem of automatic parameter selection, especially when the function computation is extremely challenging. Efficiency is improved because development time is reduced, from a matter of days to just a few hours.

In one embodiment, a method is provided. The method includes: a) identifying utilities U^{k} to be maximized when presenting user feeds to users of a social network, each utility U^{k} being associated with a respective weight xₖ for mixing items when creating the user feeds; b) identifying a maximization goal for the utilities such that a first utility U₁ is maximized while other utilities are above a respective predetermined threshold; c) initializing a counter t to zero; d) generating sample weights x₁^{t} . . . xₘ^{t}; e) performing an experiment with the sample weights x₁^{t} . . . xₘ^{t} for i users and j user feed sessions to determine utility action indicators Yᵢ^{k}(xⱼ^{t}) for each of the utilities; f) for each utility k, estimating a posterior distribution of an underlying hyperfunction ƒₖ and drawing N samples ƒₖ¹ . . . ƒₖ^{N}; g) for each drawn sample, calculating a utility function Uᵢ(x) and the weight xᵢ^{t} that maximizes the calculated utility function Uⁱ(x); h) generating an empirical distribution based on x₁^{t} . . . x_{N}^{t}) until x₁^{t} . . . x_{N}^{t} converges, incrementing the counter t and repeating operations d-i; and j) utilizing the identified weights x₁^{t} . . . xₘ^{t} after the convergence for mixing items when creating the user feeds.

In another embodiment, a system includes a memory comprising instructions, and one or more computer processors. The instructions, when executed by the one or more computer processors, cause the one or more computer processors to perform operations comprising: a) identifying utilities U^{k} to be maximized when presenting user feeds to users of a social network, each utility U^{k} being associated with a respective weight xₖ for mixing items when creating the user feeds; h) identifying a maximization goal for the utilities such that a first utility U₁ is maximized while other utilities are above a respective predetermined threshold; c) initializing a counter t to zero; d) generating sample weights x₁^{t} . . . xₘ^{t}; e) performing an experiment with the sample weights x₁^{t} . . . xₘ^{t} for i users and j user feed sessions to determine utility action indicators Yᵢ^{k}(xⱼ^{t}) for each of the utilities; f) for each utility k, estimating a posterior distribution of an underlying hyperfunction ƒₖ and drawing N samples ƒₖ¹ . . . ƒₖ^{N}; g) for each drawn sample, calculating a utility function Uⁱ(x) and the weight xᵢ^{t} that maximizes the calculated utility function Uⁱ(x); h) generating an empirical distribution based on x₁^{t} . . . x_{N}^{t}; i) until x₁^{t} . . . x_{N}^{t} converges, incrementing the counter t and repeating operations d-i; and j) utilizing the identified weights x₁^{t} . . . xₘ^{t} after the convergence for mixing items when creating the user feeds.

In yet another embodiment, a non-transitory machine-readable storage medium includes instructions that, when executed by a machine, cause the machine to perform operations comprising: a.) identifying utilities U^{k} to be maximized when presenting user feeds to users of a social network, each utility U^{k} being associated with a respective weight xₖ for mixing items when creating the user feeds; b.) identifying a maximization goal for the utilities such that a first utility U₁ is maximized while other utilities are above a respective predetermined threshold; c) initializing a counter t to zero; d) generating sample weights x₁^{t} . . . xₘ^{t}; e) performing an experiment with the sample weights xₗ^{t} . . . xₘ^{t} for i users and j user feed sessions to determine utility action indicators Yᵢ^{k}(xⱼ^{t}) for each of the utilities; f) for each utility k, estimating a posterior distribution of an underlying hyperfunction ƒₖ and drawing N samples ƒₖ¹ . . . ƒₖ^{N}; g) for each drawn sample, calculating a utility function Uⁱ(x) and the weight xᵢ^{t} that maximizes the calculated utility function Uⁱ(x); h) generating an empirical distribution based on xx₁^{t} . . . x_{N}¹; i) until x₁^{t} . . . x_{N}^{t} converges, incrementing the counter t and repeating operations d-i; and j) utilizing the identified weights x₁^{t} . . . xₘ^{t} after the convergence for mixing items when creating the user feeds.

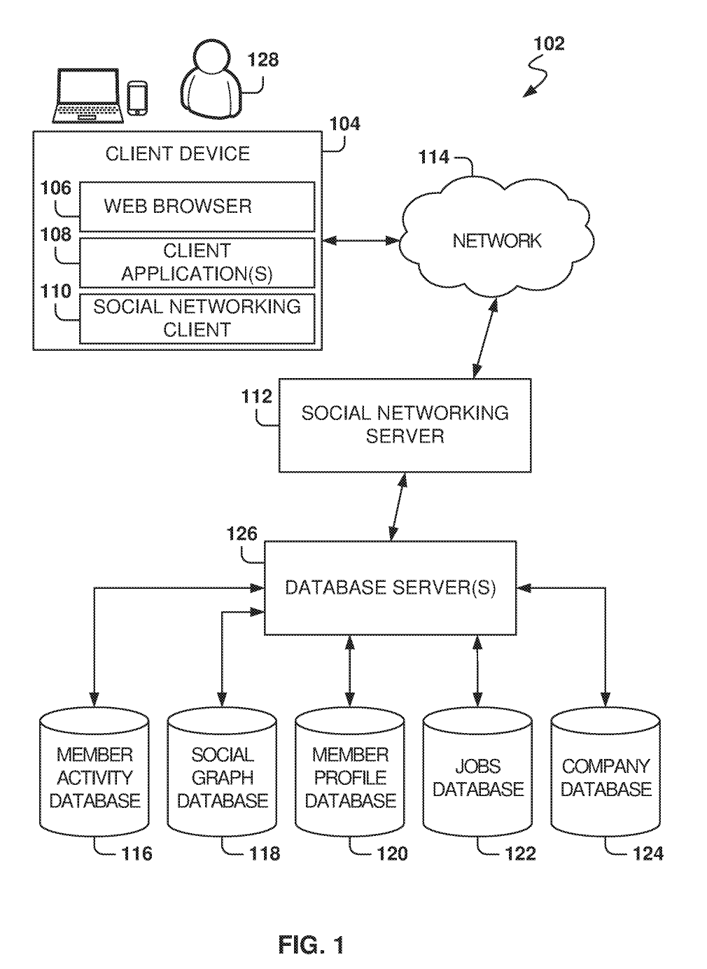

FIG. 1 is a block diagram illustrating a networked system, according to some example embodiments, including a social networking server 112, illustrating an example embodiment of a high-level client-server-based network architecture 102. The social networking server 112 provides server-side functionality via a network 114 (e.g., the Internet or a wide area network (WAN)) to one or more client devices 104. FIG. 1 illustrates, for example, a web browser 106, client application(s) 108, and a social networking client 110 executing on a client device 104. The social networking server 112 is further communicatively coupled with one or more database servers 126 that provide access to one or more databases 116-124.

The client device 104 may comprise, but is not limited to, a mobile phone, a desktop computer, a laptop, a portable digital assistant (PDA), a smart phone, a tablet, a netbook, a multi-processor system, a microprocessor-based or programmable consumer electronic system, or any other communication device that a user 128 may utilize to access the social networking server 112. In some embodiments, the client device 104 may comprise a display module (not shown) to display information (e.g., in the form of user interfaces). In further embodiments, the client device 104 may comprise one or more of touch screens, accelerometers, gyroscopes, cameras, microphones, global positioning system (GPS) devices, and so forth.

In one embodiment, the social networking server 112 is a network-based appliance that responds to initialization requests or search queries from the client device 104. One or more users 128 may be a person, a machine, or other means of interacting with the client device 104. In various embodiments, the user 128 is not part of the network architecture 102, but may interact with the network architecture 102 via the client device 104 or another means. For example, one or more portions of the network 114 may be an ad hoc network, an intranet, an extranet, a virtual private network (VPN), a local area network (LAN), a wireless LAN (WLAN), a WAN, a wireless WAN (WWAN), a metropolitan area network (MAN), a portion of the Internet, a portion of the Public Switched Telephone Network (PSTN), a cellular telephone network, a wireless network, a WiFi network, a WiMax network, another type of network, or a combination of two or more such networks.

The client device 104 may include one or more applications (also referred to as “apps”) such as, but not limited to, the web browser 106, the social networking client 110, and other client applications 108, such as a messaging application, an electronic mail (email) application, a news application, and the like. In some embodiments, if the social networking client 110 is present in the client device 104, then the social networking client 110 is configured to locally provide the user interface for the application and to communicate with the social networking server 112, on an as-needed basis, for data and/or processing capabilities not locally available (e.g., to access a member profile, to authenticate a user 128, to identify or locate other connected members, etc.). Conversely, if the social networking client 110 is not included in the client device 104, the client device 104 may use the web browser 106 to access the social networking server 112.

Further, while the client-server-based network architecture 102 is described with reference to a client-server architecture, the present subject matter is of course not limited to such an architecture, and could equally well find application in a distributed, or peer-to-peer, architecture system, for example.

In addition to the client device 104, the social networking server 112 communicates with the one or more database server(s) 126 and database(s) 116-124. In one example embodiment, the social networking server 112 is communicatively coupled to a member activity database 116, a social graph database 118, a member profile database 120, a jobs database 122, and a company database 124. The databases 116-124 may be implemented as one or more types of databases including, but not limited to, a hierarchical database, a relational database, an object-oriented database, one or more flat files, or combinations thereof.

The member profile database 120 stores member profile information about members who have registered with the social networking server 112. With regard to the member profile database 120, the member may include an individual person or an organization, such as a company, a corporation, a nonprofit organization, an educational institution, or other such organizations.

Consistent with some example embodiments, when a user initially registers to become a member of the social networking service provided by the social networking server 112, the user is prompted to provide some personal information, such as name, age (e.g., birth date), gender, interests, contact information, home town, address, spouse's and/or family members' names, educational background (e.g., schools, majors, matriculation and/or graduation dates, etc.), employment history, professional industry (also referred to herein simply as “industry”), skills, professional organizations, and so on. This information is stored, for example, in the member profile database 120. Similarly, when a representative of an organization initially registers the organization with the social networking service provided by the social networking server 112, the representative may be prompted to provide certain information about the organization, such as a company industry. This information may be stored, for example, in the member profile database 120. In some embodiments, the profile data may be processed (e.g., in the background or offline) to generate various derived profile data. For example, if a member has provided information about various job titles that the member has held with the same company or different companies, and for how long, this information may be used to infer or derive a member profile attribute indicating the member's overall seniority level, or seniority level within a particular company. In some example embodiments, importing or otherwise accessing data from one or more externally hosted data sources may enhance profile data for both members and organizations. For instance, with companies in particular, financial data may be imported from one or more external data sources, and made part of a company's profile.

In some example embodiments, the company database 124 stores information regarding companies in the member's profile. A company may also be a member, but some companies may not be members of the social network although some of the employees of the company may be members of the social network. The company database 124 includes company information, such as name, industry, contact information, website, address, location, geographic scope, and the like.

As users interact with the social networking service provided by the social networking server 112, the social networking server 112 is configured to monitor these interactions. Examples of interactions include, but are not limited to, commenting on posts entered by other members, viewing member profiles, editing or viewing a member's own profile, sharing content outside of the social networking service (e.g., an article provided by an entity other than the social networking server 112), updating a current status, posting content for other members to view and comment on, posting job suggestions for the members, searching job posts, and other such interactions. In one embodiment, records of these interactions are stored in the member activity database 116, which associates interactions made by a member with his or her member profile stored in the member profile database 120. In one example embodiment, the member activity database 116 includes the posts created by the users of the social networking service for presentation on user feeds.

The jobs database 122 includes job postings offered by companies in the company database 124. Each job posting includes job-related information such as any combination of employer, job title, job description, requirements for the job, salary and benefits, geographic location, one or more job skills required, day the job was posted, relocation benefits, and the like.

In one embodiment, the social networking server 112 communicates with the various databases 116-124 through the one or more database server(s) 126. In this regard, the database server(s) 126 provide one or more interfaces and/or services for providing content to, modifying content in, removing content from, or otherwise interacting with the databases 116-124. For example, and without limitation, such interfaces and/or services may include one or more Application Programming Interfaces (APIs), one or more services provided via a Service-Oriented Architecture (SOA), one or more services provided via a Representational State Transfer (REST)-Oriented Architecture (ROA), or combinations thereof. In an alternative embodiment, the social networking server 112 communicates with the databases 116-124 and includes a database client, engine, and/or module, for providing data to, modifying data stored within, and/or retrieving data from the one or more databases 116-124.

While the database server(s) 126 is illustrated as a single block, one of ordinary skill in the art will recognize that the database server(s) 126 may include one or more such servers. For example, the database server(s) 126 may include, but are not limited to, a Microsoft® Exchange Server, a Microsoft® Sharepoint® Server, a Lightweight Directory Access Protocol (LDAP) server, a MySQL database server, or any other server configured to provide access to one or more of the databases 116-124, or combinations thereof. Accordingly, and in one embodiment, the database server(s) 126 implemented by the social networking service are further configured to communicate with the social networking server 112.

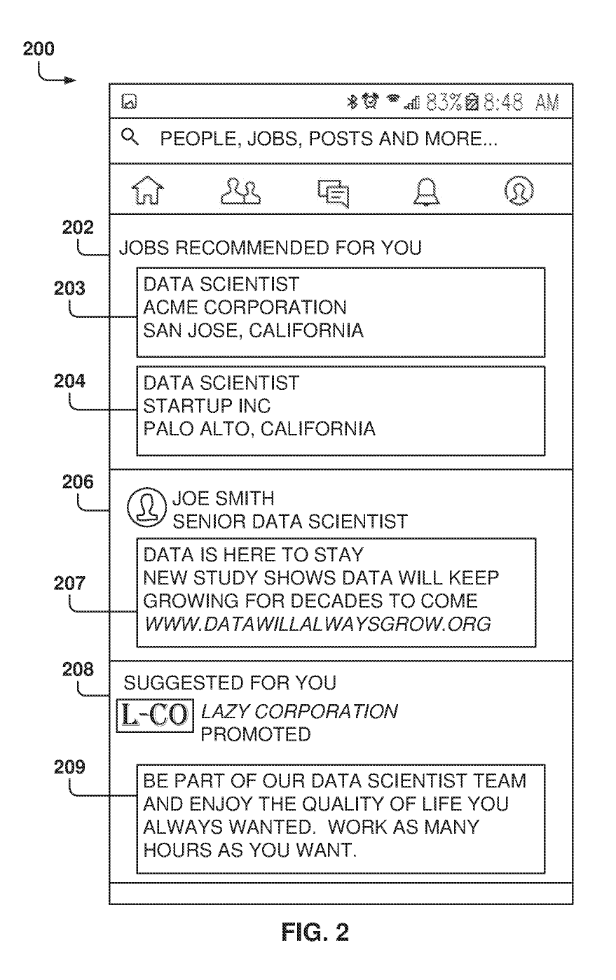

FIG. 2 is a screenshot of a user feed 200 that includes items in different categories, according to some example embodiments. In the example embodiment of FIG. 2, the user feed 200 includes different categories, such as job recommendations 202, user posts 206, and sponsored items 208, and other embodiments may include additional categories.

In one example embodiment, the social network user interface provides the job recommendations 202 (e.g., job posts 203 and 204) that match the job interests of the user and that are presented with a specific job search request from the user.

The user posts 206 include items 207 posted by users of the social network, such as connections of the user, to make comments on the social network or include articles or webpages of interest.

The sponsored items 208 are items 209 placed by sponsors of the social network, which pay a fee for posting those items on user feeds, and may include advertisements or links to webpages that the sponsors want to promote.

Although the categories are shown as separated within the user feed 200, the items from the different categories may be intermixed, and not just be presented as a block. Thus, the user feed 200 may include a large number of items from each of the categories, and the social network decides the order in which these items are presented to the user based on the desired utilities.

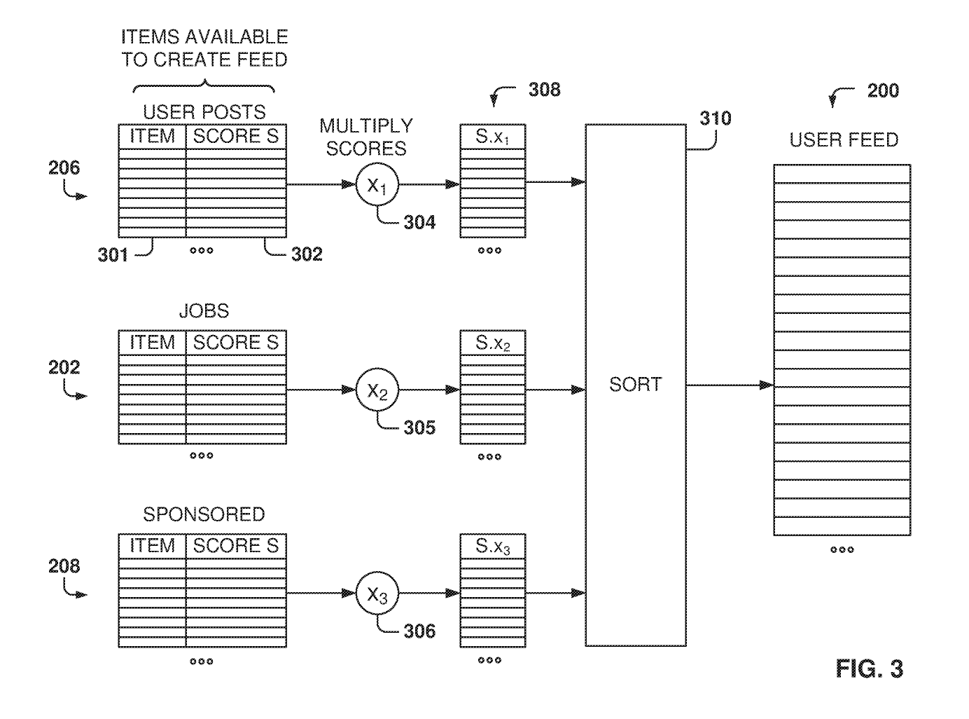

FIG. 3 illustrates a process for creating the user feed 200, according to some example embodiments. Embodiments presented include methods for finding tuning parameters 304-306 to mix items from different categories. Although three different categories are illustrated, additional or fewer categories may be included in the user feed 200.

Each item 301 is associated with a respective score S 302, and each category has a tuning parameter xᵢ 304-306 to rank the feed items. After the respective tuning parameters are applied, each of the items will have a tuned score 308 of S.xⱼ, where xⱼ corresponds to the tuning parameter for the category of the respective item. The items are sorted 310 based on the tuned scores 308 and presented on the user feed 200.

Embodiments determine the tuning parameters xᵢ that optimize the utility for each of the categories. For example, it may be desired to maximize user engagement on the feed, while increasing the revenue associated with user clicks on revenue-generating items in the social network. The tuning parameters are determined based on existing data, and not just on experimentation.

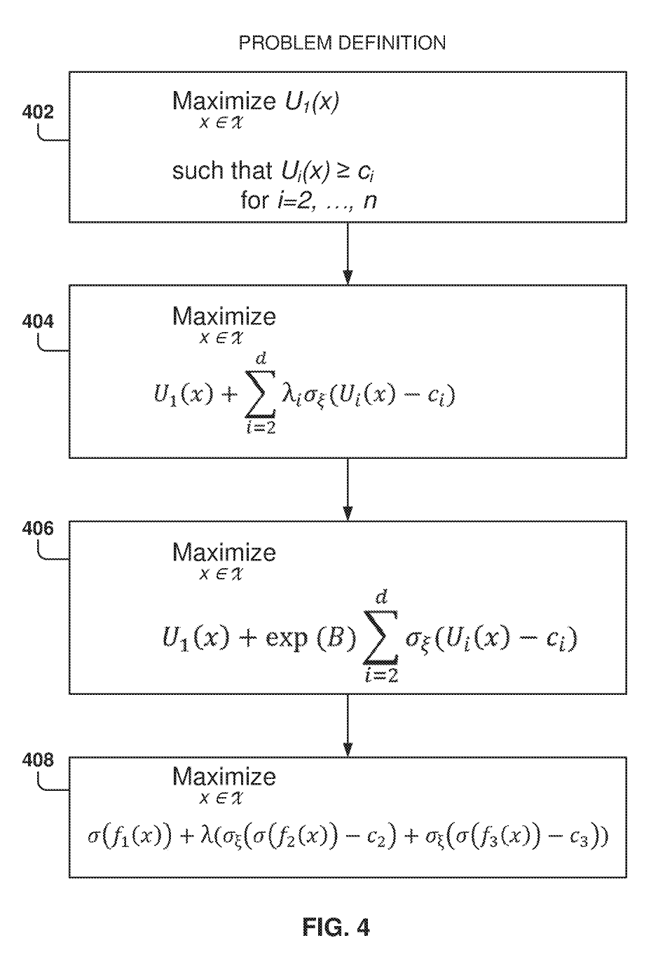

FIG. 4 illustrates a problem definition for selecting the tuning parameters, according to some example embodiments. In some example embodiments, there are n different utilities Uᵢ(x), with i-1 . . . n. Here, x denotes the multivariate weight vector, where x ∈ X, and X is a closed and bounded set. It is desired to maximize a particular metric, such as U₁, while keeping each of the other metrics above a respective particular threshold cᵢ.

Formally, it is desired to obtain the following goal 402:

Maximize U₁(x), with x ∈ X, such that Uᵢ(x)≤cᵢ, for i=2 . . . n.

For example, it is desired to maximize user interactions on the feed (U₁), keep jobs revenue U₂ at least above c₂, and keep revenue from sponsored ads U₃ at least above c₃, so that total revenue does not drop below a certain threshold.

In some example embodiments, cᵢ is set as 0.98 times a control value, although other multipliers may be used. This multiplier means a 2% drop from the control value. For example, if the estimated probability in the control model for job clicks is 20%, then c₂ is set to 0.98*0.2, or 0.196.

This goal 402 may be rewritten in a simpler form, by introducing the Lagrangian, as goal 404:

Maximize, for x ∈X, U₁(x)+Σᵢ₌₂^{d}λᵢσ_{ξ}(Uᵢ(x)−cᵢ)

Here, σ_{ξ} is equal to 1/(1+exp(−ξ)), for some large ξ, and σ_{ξ} denotes the smoothing function which takes the value 1 for most positive values and 0 for negative values with a smoothing effect on the corner. The smoothing function, called the logit function, is similar to a step function, but smoothed gradually on the corner of the step based on the value of ξ. Thus, for the i^{th} satisfied constraint, λᵢ is added to the function value, and if i is not satisfied, 0 is added.

The value of λᵢ can help identify how many constraints are satisfied or violated. Specifically, since each Uᵢ is continuous and X is compact, there is sup_{x∈X}Uᵢ(x)≤B, for some B. Thus, we can set λᵢ=exp(B) to help identify if the maximum value has been reached while satisfying all constraints. In some example embodiments, λᵢ is greater than one, such as five.

Specifically, the maximum, after satisfying all constraints, should lie in the range ((d−1)exp(B), B+(d−1)exp(B)). If j∈{0, . . . , d−1} constraints are violated, then the optimized value lies in the range ((d−1−j)exp(B), B+(d−1−j)exp(B)). This enables identifying if a feasible solution has been identified.

Thus, it is desired to solve the following problem 406:

$${Maximize}_{x ∈ X} {U}_{1} ( x ) + exp ( B ) {\sum }_{i = 2}^{d} {σ}_{ξ} ( {U}_{i} ( x ) - {c}_{i} )$$

In some example embodiments, U₁ is Engaged Feed Sessions (EFS) (which measures interactions of the user with the feed), U₂ is job clicks, and U₃ is clicks on sponsored updates. As used herein, Yᵢⁿⱼ is the utility action indicator, which indicates if the user i has acted on utility n during the j^{th} session (e.g., the user clicks on an item created by another user, or the user clicks to view a job posting).

The first utility U₁ is associated with an EFS, which is a session where the user clicks a “like,” comments, shares, or scrolls down 10 feed items. Thus, for each session j, it is determined if the session is an EFS or not (e.g., whether the user acted on utility U₁). If n feed sessions are shown to users, Y¹ is the total number of EFSs among these n users. The goal is to maximize EFSs, while keeping job clicks and revenue from sponsored updates at, or above, a minimum threshold.

Yᵢ¹ⱼ(x) indicates if the i^{th} user has an EFS in the j^{th} session when the user feed is served by parameter x (e.g., the weight vector), and it can have a value of 1 (for yes) or 0 (for no). For example, having an EFS means that the user has clicked on something on the session, shared something, liked something, commented on something, or viewed a large number of items on the feed by scrolling deep into the feed. On the other hand, if the user just comes to the feed and goes away without any type of interaction, then that value of Yᵢ¹ⱼ(x) is zero. Further, because each feed is generated by x (which includes x₁, x₂, and x₃), Yᵢ¹ⱼ may be described as a function of x.

Yᵢ²ⱼ(x) indicates if the i^{th} user clicks on a job in the j^{th} session when the user feed is served by parameter x, and it can have a value of 1 (for yes) or 0 (for no). Yᵢ³ⱼ(x) indicates if the i^{th} user clicks on a sponsored update in the j^{th} session when the user feed is served by parameter x, and it can have a value of 1 (for yes) or 0 (for no).

Although these three random variables may not be independent, the initial modeling procedure assumes independence. Initially, these random variables are modeled as Yᵢ^{k}ⱼ(x)˜Bernoulli(σ(ƒₖ(x))), where σ( ) is the logit function and ƒₖ is assumed to be smooth and coming from a Gaussian Process prior with mean 0 and covariance kernel Kₙ^{k for k=}1, 2, 3. The function ƒ, the underlying hyperfunction corresponding to the hyperparameters, is assumed to be a smooth function. One goal is to model these hyperparameters that generate this kind of observation. The σ function causes the value of Y to be between 0 and 1.

Further, independence over k is assumed. If we add the data over j, then Yᵢ^{k}˜Binomial(nᵢ, u(ƒₖ(x))). If the data is summed up over j, the Bernoulli distribution becomes a binomial distribution. For each parameter x, we observe the aggregated data Yᵢ^{k} and nᵢ.

In this setup, the utilities are defined as follows:

U₁(x)=σ(ƒ₁(x)), corresponding to EFS, which is the probability of having an engaged feed session;

U₂(x)−σ(ƒ₂(x)), corresponding to job clicks, which is the probability of having a job click in the session; and

U₃(x)=σ(ƒ₃(x)), corresponding to clicks on sponsored updates, which is the probability of having a click on an sponsored update.

Since each utility is bounded by 1, choosing any λ greater than 1 means that the problem to be solved may be written 408 as follows:

Maximize_{(x∈X)}σ(ƒ₁(x))+λ(σ_{ξ}(σ(ƒ₂(x))−c₂)+σ_{ξ}(σ(ƒ₃(x))−c₃))

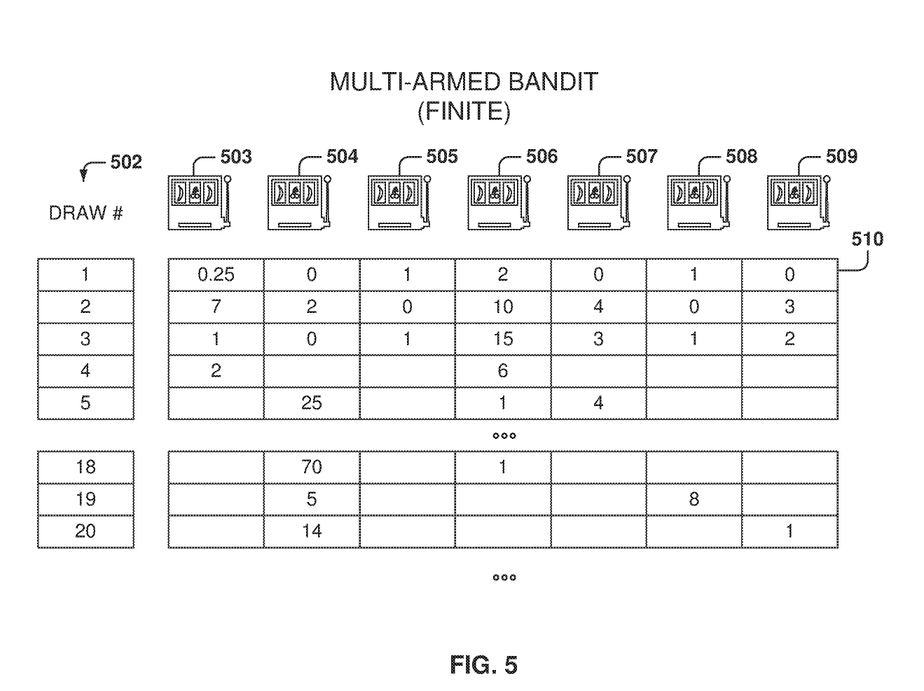

FIG. 5 illustrates a multi-armed bandit problem. In some example embodiments, the maximization problem may be solved utilizing what is referred to herein as an infinite multi-armed bandit approach. FIG. 5 illustrates the discrete multi-armed bandit problem.

In probability theory, the multi-armed bandit problem (sometimes called the K-armed or N-armed bandit problem) is a problem in which a gambler at a row of slot machines 503-509 (also known as “one-armed bandits”) has to decide which machines to play, how many times to play each machine, and in which order to play them. When played, each slot machine 503-509 provides a random reward from a probability distribution specific to that machine. The objective of the gambler is to maximize the sum of rewards earned through a sequence of lever pulls or draws 502.

The tradeoff the gambler faces at each trial is between “exploitation” of the machine that has the highest expected payoff and “exploration” to get more information about the expected payoffs of the other machines. The tradeoff between exploration and exploitation is also faced in reinforcement learning.

There may be several approaches to maximizing the gambler's reward. In some approaches, the gambler starts pulling the levers and gets a few results, and then based on those results, the gambler decides to focus on the machine with the best payoff (e.g., average return) so far and start pulling on that machine. However, to make sure that the gambler has not settled on a machine without the highest payout, the gambler also explores some of the other machines over time, increasing the amount of data collected on the machines.

If a new machine becomes the best machine, the gambler may switch to the best machine and continue drawing and exploring. Over time, the machine payouts will stabilize and the gambler will have good information to continue betting on the machine, or machines, with the best payout.

The example of FIG. 5 shows how the gambler bets on each of the slot machines 503-509 three times and then chooses to focus on the slot machine 506, while exploring other slot machines in different draws, such as the slot machine 503 in draw 4, the slot machines 504 and 507 in draw 5, etc. After several draws, the gambler observes that the slot machine 504 gives the highest payout, so the gambler switches to the slot machine 504 as the main betting machine.

Returning to the maximization problem, the goal is to maximize for x₁, x₂, and x₃. However, these are real variables, so vector x may have infinite values for the possible combinations of x₁, x₂, and x₃. It could be thought that each combination of x₁, x₂, and x₃ is a slot machine, and the goal is to find the best slot machine, such that the machine gives the best utility U₁ while meeting the other constraints for the other utilities. This is why the solution presented here is referred to as the infinite multi-armed bandit approach.

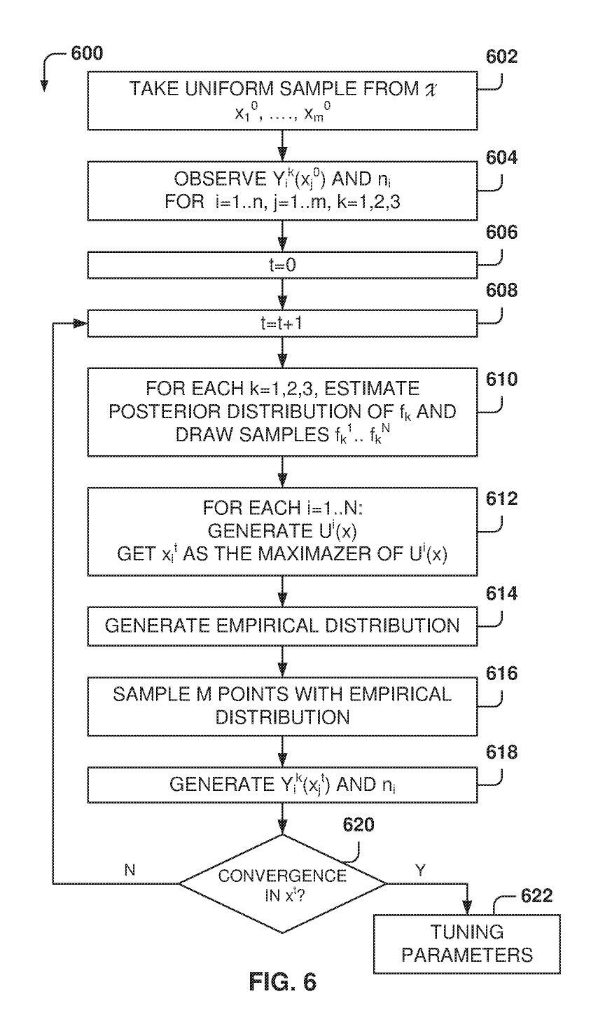

FIG. 6 is a flowchart of a method 600 for obtaining tuning parameters, according to some example embodiments. In some example embodiments, the optimization problem is solved utilizing a heuristic for choosing actions that address the exploration-exploitation dilemma in the multi-armed bandit problem. The action chosen is the action that maximizes the expected reward with respect to a randomly drawn belief. The reason why traditional optimization techniques do not work is because the form of this function is not known. If a traditional optimization algorithm is tried, the goal is to find the gradient of the function, but because the function is unknown, it is not possible to find the gradient.

The algorithm includes considering a set of contexts [symbol] a set of actions [symbol] and rewards in [symbol] . In each round, the player obtains a context x∈ [symbol] plays an action a∈ [symbol] , and receives a reward r∈ [symbol] following a distribution that depends on the context and the issued action. The aim of the player is to play actions such as to maximize the cumulative rewards. The elements of the algorithm include a likelihood function P(r|θ, a, x); a set θ of parameters θ of the distribution of r; a prior distribution P(θ) on these parameters: past observation triplets [symbol] ={(x; a; r)}; and a posterior distribution P(θ [symbol] α P(θ [symbol] )P(θ), where P(θ) is the likelihood function. Sampling includes playing the action according to the probability that it maximizes the expected reward.

For the maximization goal, an initial uniform sample on the domain is utilized. Using the data, the posterior distribution of ƒ is estimated. Repeated samples are taken from this posterior distribution to find the distribution of the maximizer of the utility. Afterwards, the next samples are drawn from this maximum distribution to get the next set of observations. This procedure is repeated till convergence, as illustrated in the method 600.

In operation 602, a uniform sample is taken from [symbol] , referred to as x₁⁰, . . . , xₘ⁰. That is, a first sequence of points is selected and the data obtained from these points is evaluated, e.g., Y.

Based on the obtained Y, the functions ƒₖ are estimated. It is assumed that there is some prior knowledge for these ƒₖ functions, and that prior knowledge may be that these functions are coming from a distribution which is a Gaussian process with a mean function 0 and a covariance kernel.

It can be said that ƒₖ is a sample from a set of many functions. We assume a certain distribution on this entire space, and that distribution is known as a Gaussian process.

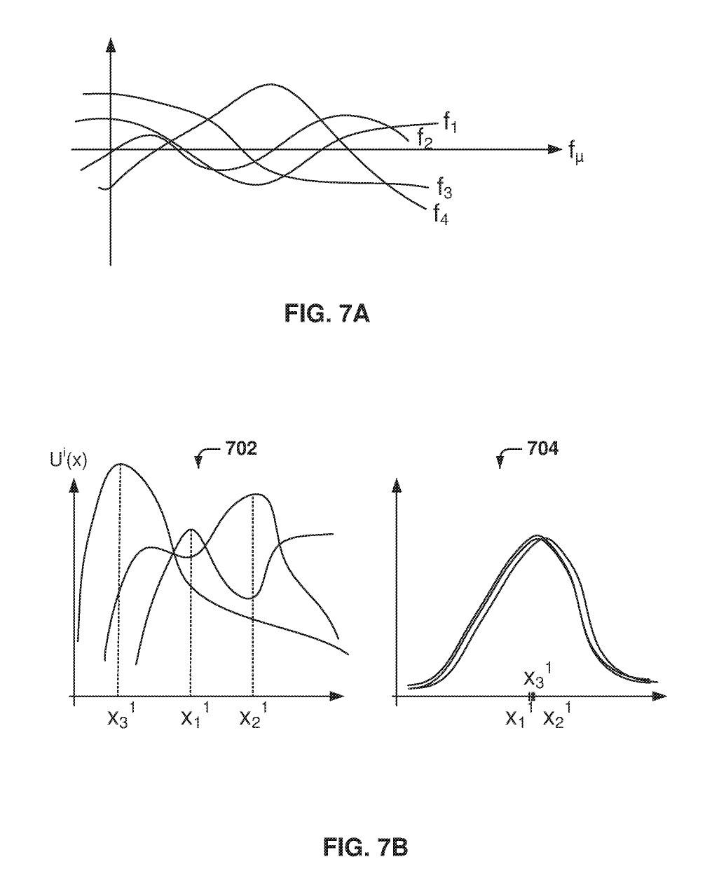

FIG. 7A shows a distribution of functions for selection, according to some example embodiments. Many different functions ƒₖ may be drawn initially in this one-dimensional example with mean μ, aiming to find the right function, around a function ƒ_{μ}. Thus, ƒₖ k may be written as a Gaussian process with a mean function μ and a covariance kernel called K.

It is assumed initially that the knowledge available is that ƒₖ is coming from some Gaussian process, and based on this prior knowledge and the data, it is possible to calculate the posterior of ƒₖ. There is some prior knowledge, which may or may not be true. Afterwards, the true data is observed from this set off x's that were sampled. Based on that true data, it is possible to gain further knowledge about ƒₖ. This is known as the posterior of ƒ.

Returning now to FIG. 6, at operation 602 the samples are taken. At operation 604, the data is observed, that is, Yᵢ^{k}(xⱼ⁰) and nᵢ, for i=1 . . . n, j=1 . . . m, and k=1 . . . 3. Further, m points are taken on domain x. For example, x could be (0.1, 0.5, 2.3). In this case, i is the number of people who are going to the system and being part of the experiment. In some example embodiments, i could be in the order of thousands or millions.

The Y values are determined by running an experiment that creates user feeds with these factors. When the user sees the user feed, the user may take some actions, such as clicking on a job, scrolling down the feed, etc. Based on the actions, the Y values are calculated.

At operation 606, a counter t is initialized to 0, and this variable t refers to the iterations performed in operations 608-620 until convergence is found. At operation 608, the counter t is incremented, such that the counter t refers to the iteration number through the loop.

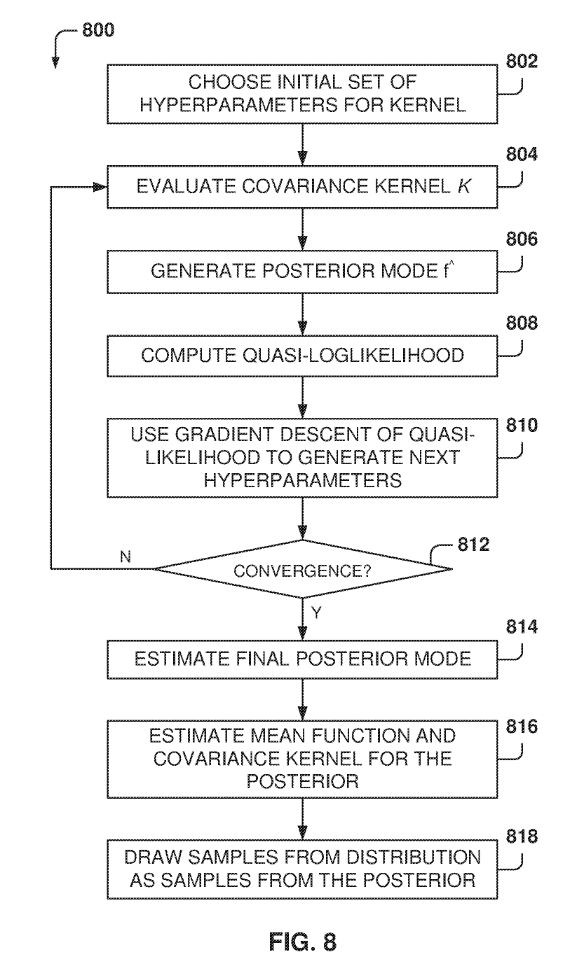

At operation 610, for each k from 1 to 3, the posterior distributions off ƒₖ are estimated and samples are drawn for ƒₖ¹ . . . ƒₖ^{N}. More details regarding the calculation of the posterior distribution are provided below with reference to FIG. 8.

There is variation involved, and at this point it is not known with certainty what the function should be. Some knowledge has been gained about the function from the data, but there may still be some variation, and the method aims at identifying the amount of the variation. In order to see the variation, many different samples are drawn, which in this case is m samples from the posterior distribution.

At operation 612, a loop is executed with i=1 to N, where N is the number of samples. In this loop, the utilities Uᵢ are calculated with the following equation:

Uⁱ(x)=σ(ƒ₁ⁱ(x))+λ(σ_{ξ}(σ(ƒ₂ⁱ(x))−c₂)+σ_{ξ}(σ(ƒ₃ⁱ(x))−c₃))

Since the functions are known, ƒ₁ⁱ(x), ƒ₂ⁱ, and ƒ₃ⁱ(x) are used, which have been generated from the posterior. Then, xᵢ^{t} is obtained as the value that maximizes Uⁱ(x). Finding xᵢ^{t} is done through a grid search. Because ƒ₁ⁱ may be evaluated at every point x, and since this is a continuous domain, it is not possible to find a value at every point x. A grid of values is taken and Uᵢ is evaluated at these grid values. Whichever x is the maximum is assigned to xᵢ^{t}.

In operation 614, the empirical distribution is generated utilizing x₁^{t} . . . x_{N}^{t}. In operation 616, the samples are generated from the empirical distribution, which are referred to as x₁^{t} . . . xₘ^{t}. Now that these in points are available, the data is regenerated and the process continues.

At operation 618, Yᵢ^{k}(x₁^{t}) is generated as well as nᵢ for i=1 . . . n, j=1 . . . m, and k=1 . . . 3. At operation 620, a check is made to determine if there is convergence for x^{t}. If there is convergence, the method 600 flows to operation 622; otherwise, the method 600 flows back to operation 608 and the loop is run again. At operation 622, the method 600 ends with the identified tuning parameters.

FIG. 7B illustrates how to determine if there is convergence. FIG. 7B shows the distributions of functions before and after convergence, according to some example embodiments. A chart 702 illustrates how, initially, there are many possible Uᵢ functions and the maximums x₁¹, x₂¹, and x₃¹ for the respective Uᵢ functions are spread out. But as the loop is executed more times with additional data, a chart 704 shows how the maximums converge and get close to each other.

At each loop, there is a new resampling to generate new data that provides more information about the functions. It should be noted that with each loop more data is obtained, because the data from all the experiments is aggregated. The maximums get closer at each iteration until there is convergence into the true maximum (or substantial true maximum within a predetermined small range). This means that convergence has taken place as these points have aggregated towards one point (or a small range of points), and it is concluded that that is the true maximum.

In some example embodiments, convergence is determined when the values are within a predetermined threshold of difference, such that the maximum is situated within a small convergence region.

FIG. 8 is a flowchart of a method 800 for estimating a posterior distribution, according to some example embodiments. While the various operations in this flowchart are presented and described sequentially, one of ordinary skill will appreciate that some or all of the operations may be executed in a different order, be combined or omitted, or be executed in parallel.

The hyperparameters are estimated using a quasi-likelihood approach to select and calculate the hyperparameters. The method 800 may be divided into two major tasks: estimating the hyperparameters, comprising operations 802-812; and estimating the posterior, comprising operations 814-818.

At operation 802, an initial set of hyperparameters are chosen for the covariance kernel. Model selection may help both to refine the predictions of the model and give a valuable interpretation to the user about the properties of the data, e.g., that a non-stationary covariance function may be selected over a stationary one.

A multitude of possible families of covariance functions exists, including squared exponential, polynomial, neural network, etc. Each of these families typically has a number of free hyperparameters whose values also need to be determined. Choosing a covariance function, for a particular application, thus comprises both setting of hyperparameters within a family and comparing across different families. The term “model selection” is utilized to cover both meanings. The selection of a covariance function and its parameters is referred to as training a Gaussian process.

Covariance functions such as the squared exponential can be parameterized in terms of hyperparameters. For example:

k(xₚ, x_{q})=σ²exp(−½(xₚ−x_{q})^{T}M(xₚ−x_{q}))+σ²δ_{pq}

Here, 0=({M},σᵢ², σₙ²) is a vector containing all the hyperparameters, and {M} denotes the parameters in the symmetric matrix M.

It is known that ƒ is following some prior knowledge that has a mean of 0. The data is X and Y (e.g., data=(X, Y)), and the goal is to find the distribution of ƒ given the data.

The first step is understanding what the kernel is. The kernel may be chosen to be anything. In some example embodiments, the kernel is the squared exponential kernel.

First, θ is estimated because its value is not known. The set of hyperparameters θ₀ is estimated. Given this value of θ and given any x, it is possible to determine ƒ(x), where ƒ(x) is distributed normally according to a Gaussian process, ƒ˜GP(0, K_{θ}).

For the case with one variable x₁, ƒ(x₁^{k}) may be expressed as:

ƒ(x^{k})˜N(μ(x^{k}, θ^{k}), Var(x^{k}, θ^{k}))

For the case where we have two variables x₁ and x₂, then we have ƒ_{θ}(x₁) and f_{θ}(x₂). There is a vector for the two functions, as follows:

$$( \begin{matrix}{f}_{θ} ( {x}_{1} ) \\ {f}_{θ} ( {x}_{2} )\end{matrix} ) ∼ N ( ( \begin{matrix}0 \\ 0\end{matrix} ) , ( \begin{matrix}{K}_{θ} ( {x}_{1} , {x}_{1} ) & {K}_{θ} ( {x}_{1} , {x}_{2} ) \\ {K}_{θ} ( {x}_{2} , {x}_{1} ) & {K}_{θ} ( {x}_{2} , {x}_{2} )\end{matrix} ) )$$

It is a normal distribution with mean (0 0) and variance K_{θ}(0) (zero because it is a function of the difference x₁−x₁), K_{θ}(x₁, x₂), K_{θ}(x₂, x₁), and K_{θ}(0).

Generally speaking, K_{θ}(a,b), may be described as follows:

$${K}_{θ} ( a , b ) = \frac{1}{α} exp ( - \frac{1}{2} {\sum }_{i = 1}^{3} \frac{{( {a}_{i} - {b}_{i} )}^{2}}{{l}_{i}^{2}} )$$

Here, θ is a vector (a, I₁, I₂, I₃). The initial set of hyperparameters is referred to as θ₀. Once θ₀ is defined, the covariance kernel K is calculated, at operation 804, using the hyperparameters. K is a matrix evaluated at x₁, x₂, . . . , xₘ points. If x has dimension n, the matrix will have a dimension of n×n. Once K is known, the posterior mode f̂ is generated at operation 806. The posterior mode f̂ provides the best estimate given the data.

At operation 808, the quasi-loglikelihood of Y given x and θ is calculated based on K and f̂. The posterior of the data given the hyperparameters is not a closed form.

At operation 810, the gradient descent of the quasi-likelihood Q is used to generate the next choice of the hyperparameters, which are calculated by maximizing the quasi-likelihood. For example, if we have θ₀, θ₁ is generated next.

Once θ₁ is obtained, f₁̂ is calculated from θ₁ as indicated above. The process continues until the optimal parameter θ* is obtained when convergence is detected at operation 812.

Once convergence is detected, the method 800 flows to operation 814 to estimate the final posterior mode. At operation 816, the mean function and the covariance kernel for the posterior are estimated. It should be noted that it is possible to maximize each value of xᵢ^{t}, but it is not possible to do this for all x because there are infinite possibilities. Thus, a grid of points is used to find the convergence. The grid may be a regular grid or an irregular grid. The functions are evaluated for these grid points. At operation 818, samples from the distribution are drawn as samples from the calculated posterior.

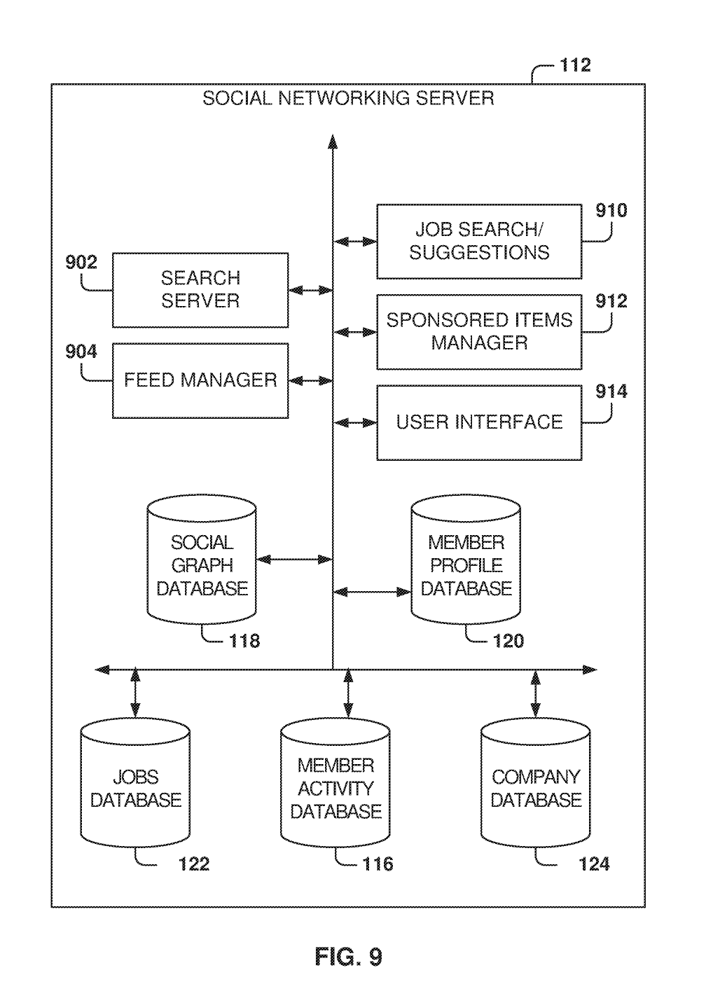

FIG. 9 illustrates a social networking server 112 for implementing example embodiments. In one example embodiment, the social networking server 112 includes a search server 902, a feed manager 904, a job search/suggestions server 910, a sponsored items manager 912, a user interface 914, and a plurality of databases, which include the social graph database 118, the member profile database 120, the jobs database 122, the member activity database 116, and the company database 124.

The search server 902 performs data searches on the social network, such as searches for members or companies. The job search/suggestions server 910 performs job searches based on a search query or based on a member profile in order to offer job suggestions. In some example embodiments, the job search/suggestions server 910 includes a machine-learning algorithm for performing the searches, which utilizes a plurality of features for selecting and scoring the jobs. The features include, at least, one or more of title, industry, skills, member profile, company profile, job title, job data, region, and salary range.

The feed manager 904 analyzes data in order to determine parameters for creating the user feed, and also creates the user feed for the user based on those parameters. The feed manager 904 also performs the experiments to evaluate the feed parameters. For example, the feed manager 904 performs the operations illustrated in FIGS. 3-4 and 6-8.

The user interface 914 communicates with the client devices 104 to exchange user interface data for presenting the user interface 914 to the user. It is to be noted that the embodiments illustrated in FIG. 9 are examples and do not describe every possible embodiment. Other embodiments may utilize different servers or additional servers, combine the functionality of two or more servers into a single server, utilize a distributed server pool, and so forth. The embodiments illustrated in FIG. 9 should therefore not be interpreted to be exclusive or limiting, but rather illustrative.

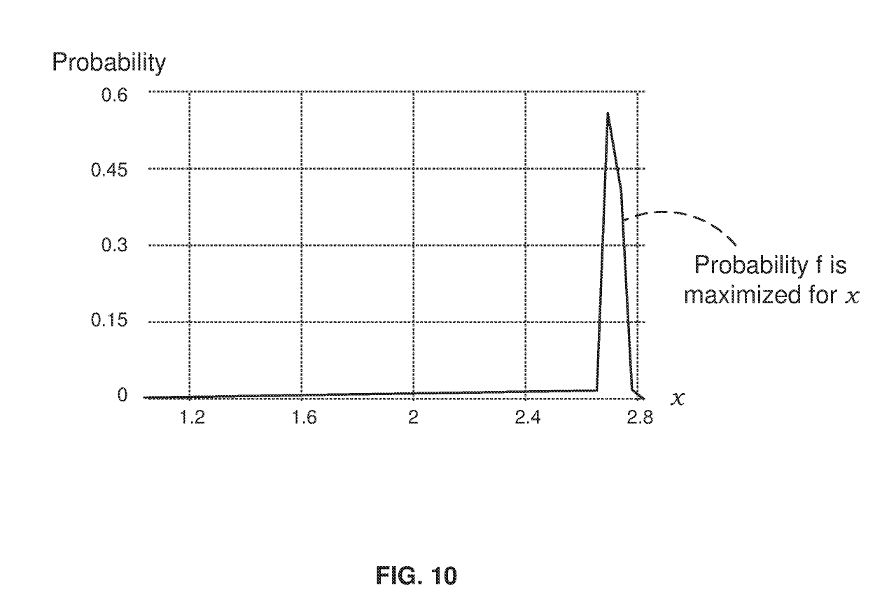

FIG. 10 is a chart illustrating the convergence of the probability that ƒ is maximized for a given x, according to some example embodiments. The horizontal axis corresponds to the x value and the vertical axis corresponds to the probability that the function ƒ(x) is maximized for that x. Different experiments were run, following the methodology described above, and it was determined that convergence occurred when the value of x was about 2.7. This experiment is proof that the methodology finds the convergence to find the optimal values.

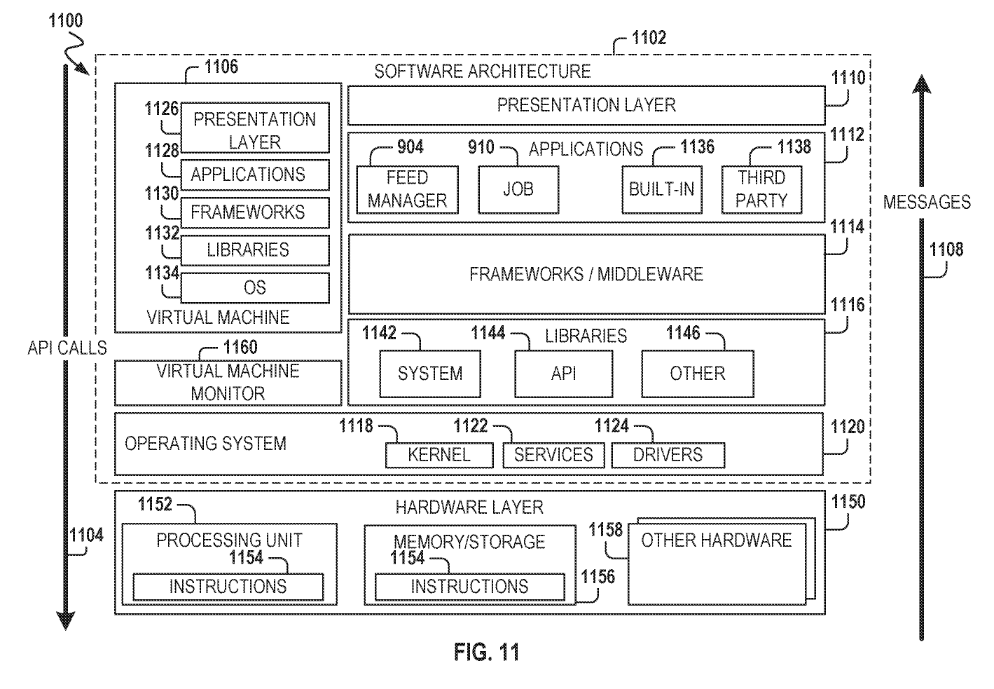

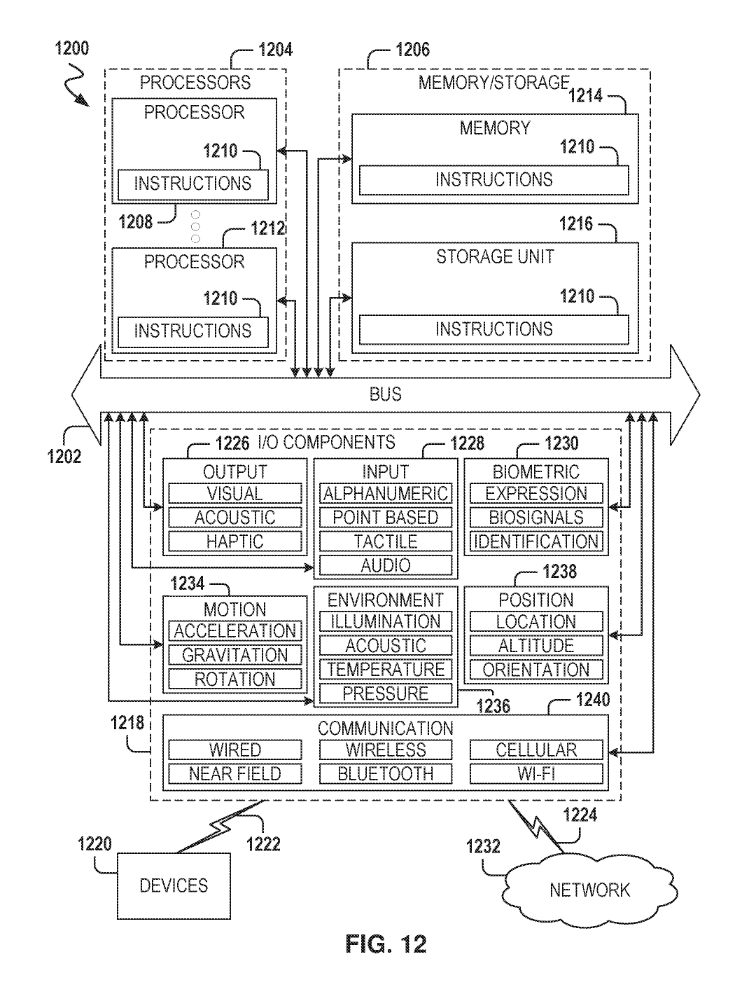

FIG. 11 is a block diagram 1100 illustrating a representative software architecture 1102, which may be used in conjunction with various hardware architectures herein described. FIG. 11 is merely a non-limiting example of a, software architecture 1102, and it will be appreciated that many other architectures may be implemented to facilitate the functionality described herein. The software architecture 1102 may be executing on hardware such as a machine 1200 of FIG. 12 that includes, among other things, processors 1204, memory/storage 1206, and input/output (I/O) components 1218. A representative hardware layer 1150 is illustrated and may represent, for example, the machine 1200 of FIG. 12. The representative hardware layer 1150 comprises one or more processing units 1152 having associated executable instructions 1154. The executable instructions 1154 represent the executable instructions of the software architecture 1102, including implementation of the methods, modules, and so forth of FIGS. 1-10. The hardware layer 1150 also includes memory and/or storage modules 1156, which also have the executable instructions 1154. The hardware layer 1150 may also comprise other hardware 1158, which represents any other hardware of the hardware layer 1150, such as the other hardware illustrated as part of the machine 1200.

In the example architecture of FIG. 11, the software architecture 1102 may be conceptualized as a stack of layers where each layer provides particular functionality. For example, the software architecture 1102 may include layers such as an operating system 1120, libraries 1116, frameworks/middleware 1114, applications 1112, and a presentation layer 1110. Operationally, the applications 1112 and/or other components within the layers may invoke application programming interface (API) calls 1104 through the software stack and receive a response, returned values, and so forth illustrated as messages 1108 in response to the API calls 1104. The layers illustrated are representative in nature, and not all software architectures have all layers. For example, some mobile or special-purpose operating systems may not provide a frameworks/middleware 1114 layer, while others may provide such a layer. Other software architectures may include additional or different layers.

The operating system 1120 may manage hardware resources and provide common services. The operating system 1120 may include, for example, a kernel 1118, services 1122, and drivers 1124. The kernel 1118 may act as an abstraction layer between the hardware and the other software layers. For example, the kernel 1118 may be responsible for memory management, processor management (e.g., scheduling), component management, networking, security settings, and so on. The services 1122 may provide other common services for the other software layers. The drivers 1124 may be responsible for controlling or interfacing with the underlying hardware. For instance, the drivers 1124 may include display drivers, camera drivers, Bluetooth® drivers, flash memory drivers, serial communication drivers (e.g., Universal Serial Bus (USB) drivers), Wi-Fi® drivers, audio drivers, power management drivers, and so forth depending on the hardware configuration.

The libraries 1116 may provide a common infrastructure that may be utilized by the applications 1112 and/or other components and/or layers. The libraries 1116 typically provide functionality that allows other software modules to perform tasks in an easier fashion than by interfacing directly with the underlying operating system 1120 functionality (e.g., kernel 1118, services 1122, and/or drivers 1124). The libraries 1116 may include system libraries 1142 (e.g., C standard library) that may provide functions such as memory allocation functions, string manipulation functions, mathematic functions, and the like. In addition, the libraries 1116 may include API libraries 1144 such as media libraries (e.g., libraries to support presentation and manipulation of various media formats such as MPEG4, H.264, MP3, AAC, AMR, JPG, PNG), graphics libraries (e.g., an OpenGL framework that may be used to render two-dimensional and three-dimensional graphic content on a display), database libraries (e.g., SQLite that may provide various relational database functions), web libraries (e.g., WebKit that may provide web browsing functionality), and the like. The libraries 1116 may also include a wide variety of other libraries 1146 to provide many other APIs to the applications 1112 and other software components/modules.

The frameworks 1114 (also sometimes referred to as middleware) may provide a higher-level common infrastructure that may be utilized by the applications 1112 and/or other software components/modules. For example, the frameworks 1114 may provide various graphic user interface (GUI) functions, high-level resource management, high-level location services, and so forth. The frameworks 1114 may provide a broad spectrum of other APIs that may be utilized by the applications 1112 and/or other software components/modules, some of which may be specific to a particular operating system or platform.

The applications 1112 include the feed manager 904, the job search/suggestions server 910, other modules as shown in FIG. 9 (not shown), built-in applications 1136, and third-party applications 1138. Examples of representative built-in applications 1136 may include, but are not limited to, a contacts application, a browser application, a book reader application, a location application, a media application, a messaging application, and/or a game application. The third-party applications 1138 may include any of the built-in applications 1136 as well as a broad assortment of other applications. In a specific example, the third-party application 1138 (e.g., an application developed using the Android™ or iOS™ software development kit (SDK) by an entity other than the vendor of the particular platform) may be mobile software running on a mobile operating system such as iOS™, Android™, Windows® Phone, or other mobile operating systems. In this example, the third-party application 1138 may invoke the API calls 1104 provided by the mobile operating system such as the operating system 1120 to facilitate functionality described herein.

The applications 1112 may utilize built-in operating system functions (e.g., kernel 1118, services 1122, and/or drivers 1124), libraries (e.g., system libraries 1142, API libraries 1144, and other libraries 1146), or frameworks/middleware 1114 to create user interfaces to interact with users of the system. Alternatively, or additionally, in some systems, interactions with a user may occur through a presentation layer, such as the presentation layer 1110. In these systems, the application/module “logic” may be separated from the aspects of the application/module that interact with a user.

Some software architectures utilize virtual machines. In the example of FIG. 11, this is illustrated by a virtual machine 1106. A virtual machine creates a software environment where applications/modules may execute as if they were executing on a hardware machine (such as the machine 1200 of FIG. 12, for example). The virtual machine 1106 is hosted by a host operating system (e.g., the operating system 1120 in FIG. 11) and typically, although not always, has a virtual machine monitor 1160, which manages the operation of the virtual machine 1106 as well as the interface with the host operating system (e.g., the operating system 1120). A software architecture executes within the virtual machine 1106 such as an operating system 1134, libraries 1132, frameworks/middleware 1130, applications 1128, and/or a presentation layer 1126. These layers of software architecture executing within the virtual machine 1106 may be the same as corresponding layers previously described or may be different.

FIG. 12 is a block diagram illustrating components of a machine 1200, according to some example embodiments, able to read instructions from a machine-readable medium (e.g., a machine-readable storage medium) and perform any one or more of the methodologies discussed herein. Specifically, FIG. 12 shows a diagrammatic representation of the machine 1200 in the example form of a computer system, within which instructions 1210 (e.g., software, a program, an application, an applet, an app, or other executable code) for causing the machine 1200 to perform any one or more of the methodologies discussed herein may be executed. For example, the instructions 1210 may cause the machine 1200 to execute the flow diagrams of FIGS. 3, 4, 6, and 8. Additionally, or alternatively, the instructions 1210 may implement the programs of the social networking server 112, including the search server 902, the feed manager 904, the job search/suggestions server 910, and the user interface 914 of FIG. 9, and so forth. The instructions 1210 transform the general, non-programmed machine 1200 into a particular machine 1200 programmed to carry out the described and illustrated functions in the manner described.

In alternative embodiments, the machine 1200 operates as a standalone device or may be coupled (e.g., networked) to other machines. In a networked deployment, the machine 1200 may operate in the capacity of a server machine or a client machine in a server-client network environment, or as a peer machine in a peer-to-peer (or distributed) network environment. The machine 1200 may comprise, but not be limited to, a switch, a controller, a server computer, a client computer, a personal computer (PC), a tablet computer, a laptop computer, a netbook, a set-top box (STB), a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 1210, sequentially or otherwise, that specify actions to be taken by the machine 1200. Further, while only a single machine 1200 is illustrated, the term “machine” shall also be taken to include a collection of machines 1200 that individually or jointly execute the instructions 1210 to perform any one or more of the methodologies discussed herein.

The machine 1200 may include processors 1204, memory/storage 1206, and I/O components 1218, which may be configured to communicate with each other such as via a bus 1202. In an example embodiment, the processors 1204 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an Application-Specific Integrated Circuit (ASIC), a Radio-Frequency Integrated Circuit (RFIC), another processor, or any suitable combination thereof) may include, for example, a processor 1208 and a processor 1212 that may execute the instructions 1210. The term “processor” is intended to include multi-core processors that may comprise two or more independent processors (sometimes referred to as “cores”) that may execute instructions contemporaneously. Although FIG. 12 shows multiple processors 1204, the machine 1200 may include a single processor with a single core, a single processor with multiple cores (e.g., a multi-core processor), multiple processors with a single core, multiple processors with multiple cores, or any combination thereof.

The memory/storage 1206 may include a memory 1214, such as a main memory, or other memory storage, and a storage unit 1216, both accessible to the processors 1204 such as via the bus 1202. The storage unit 1216 and memory 1214 store the instructions 1210 embodying any one or more of the methodologies or functions described herein. The instructions 1210 may also reside, completely or partially, within the memory 1214, within the storage unit 1216, within at least one of the processors 1204 (e.g., within the processor's cache memory), or any suitable combination thereof, during execution thereof by the machine 1200. Accordingly, the memory 1214, the storage unit 1216, and the memory of the processors 1204 are examples of machine-readable media.

As used herein, “machine-readable medium” means a device able to store instructions and data temporarily or permanently and may include, but is not limited to, random-access memory (RAM), read-only memory (ROM), buffer memory, flash memory, optical media, magnetic media, cache memory, other types of storage (e.g., Erasable Programmable Read-Only Memory (EPROM)), and/or any suitable combination thereof. The term “machine-readable medium” should be taken to include a single medium or multiple media (e.g., a centralized or distributed database, or associated caches and servers) able to store the instructions 1210. The term “machine-readable medium” shall also be taken to include any medium, or combination of multiple media, that is capable of storing instructions (e.g., instructions 1210) for execution by a machine (e.g., machine 1200), such that the instructions, when executed by one or more processors of the machine (e.g., processors 1204), cause the machine to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” excludes signals per se.

The I/O components 1218 may include a wide variety of components to receive input, provide output, produce output, transmit information, exchange information, capture measurements, and so on. The specific I/O components 1218 that are included in a particular machine will depend on the type of machine. For example, portable machines such as mobile phones will likely include a touch input device or other such input mechanisms, while a headless server machine will likely not include such a touch input device. It will be appreciated that the I/O components 1218 may include many other components that are not shown in FIG. 12. The I/O components 1218 are grouped according to functionality merely for simplifying the following discussion, and the grouping is in no way limiting. In various example embodiments, the I/O components 1218 may include output components 1226 and input components 1228. The output components 1226 may include visual components (e.g., a display such as a plasma display panel (PDP), a light-emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 1228 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or other pointing instruments), tactile input components (e.g., a physical button, a touch screen that provides location and/or force of touches or touch gestures, or other tactile input components), audio input components (e.g., a microphone), and the like.

In further example embodiments, the I/O components 1218 may include biometric components 1230, motion components 1234, environmental components 1236, or position components 1238 among a wide array of other components. For example, the biometric components 1230 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The motion components 1234 may include acceleration sensor components (e.g., accelerometer), gravitation sensor components, rotation sensor components (e.g., gyroscope), and so forth. The environmental components 1236 may include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detect concentrations of hazardous gases for safety or to measure pollutants in the atmosphere), or other components that may provide indications, measurements, or signals corresponding to a surrounding physical environment. The position components 1238 may include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 1218 may include communication components 1240 operable to couple the machine 1200 to a network 1232 or devices 1220 via a coupling 1224 and a coupling 1222, respectively. For example, the communication components 1240 may include a network interface component or other suitable device to interface with the network 1232. In further examples, the communication components 1240 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 1220 may be another machine or any of a wide variety of peripheral devices (e.g., a peripheral device coupled via a USB).

Moreover, the communication components 1240 may detect identifiers or include components operable to detect identifiers. For example, the communication components 1240 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 1240, such as location via Internet Protocol (IP) geo-location, location via Wi-Fi® signal triangulation, location via detecting an NFC beacon signal that may indicate a particular location, and so forth.

In various example embodiments, one or more portions of the network 1232 may be an ad hoc network, an intranet, an extranet, a VPN, a LAN, a WLAN, a WAN, a WWAN, a MAN, the Internet, a portion of the Internet, a portion of the PSTN, a plain old telephone service (POTS) network, a cellular telephone network, a wireless network, a Wi-Fi® network, another type of network, or a combination of two or more such networks. For example, the network 1232 or a portion of the network 1232 may include a wireless or cellular network and the coupling 1224 may be a Code Division Multiple Access (CDMA) connection, a Global System for Mobile communications (GSM) connection, or another type of cellular or wireless coupling. In this example, the coupling 1224 may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High-Speed Packet Access (HSPA), Worldwide Interoperability for Microwave Access (WiMAX), Long-Term Evolution (LTE) standard, others defined by various standard-setting organizations, other long-range protocols, or other data transfer technology.

The instructions 1210 may be transmitted or received over the network 1232 using a transmission medium via a network interface device (e.g., a network interface component included in the communication components 1240) and utilizing any one of a number of well-known transfer protocols (e.g., hypertext transfer protocol (HTTP)). Similarly, the instructions 1210 may be transmitted or received using a transmission medium via the coupling 1222 (e.g., a peer-to-peer coupling) to the devices 1220. The term “transmission medium” shall be taken to include any intangible medium that is capable of storing, encoding, or carrying the instructions 1210 for execution by the machine 1200, and includes digital or analog communications signals or other intangible media to facilitate communication of such software.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

1. A method comprising:
a. identifying utilities to be maximized when presenting user feeds to users of a social network, each utility being associated with a respective weight for mixing items when creating the user feeds;
b. identifying a maximization goal for the utilities such that a first utility is maximized while other utilities are above a respective predetermined threshold;
c. initializing a counter to zero;
d. generating sample weights;
e. performing an experiment with the generated sample weights for a plurality of users and a plurality of user feed sessions to determine a utility action indicator for each of the utilities for each pair of user and job;
f. for each utility, estimating a posterior distribution of an underlying hyperfunction and drawing sample hyperfunctions;
g. for each drawn sample, calculating a utility function and calculating the weight from the sample weights that maximizes the calculated utility function;
h. generating an empirical distribution based on the calculated weights;
i. until the calculated weights converge, incrementing the counter and repeating operations d-i; and
j. utilizing the identified calculated weights after the convergence for mixing the items when creating the user feeds.

2. The method as recited in claim 1, wherein mixing the items when creating the user feeds further comprises:
identifying a pool of candidates for each utility, each candidate having a candidate score;
multiplying each candidate score by the corresponding weight; and
mixing the candidates to create the user feed based on a result of the multiplying.

3. The method as recited in claim 2, wherein performing the experiment further comprises:
creating the user feeds utilizing the sample weights for mixing the candidates.

4. The method as recited in claim 1, wherein the utility action indicator for each of the utilities for each pair of user and job is determined by assigning a value of 1 when the experiment indicates that the user acted on the utility during the user feed session and assigning a value of 0 when the user did not act on the utility during the user feed session.

5. The method as recited in claim 1, wherein the utilities comprise one or more of user posts, job posts, and sponsored posts.

6. The method as recited in claim 1, wherein the utility function is calculated with based on a smoothing function of the sample hyperfunctions.

7. The method as recited in claim 1, wherein estimating the posterior distribution further comprises:
i. choosing initial values for hyperparameters;
ii. evaluating a covariance kernel based on the hyperparameters;
iii. generating a posterior mode;
iv. computing a quasi-loglikelihood;
v. checking for convergence;
vi. when convergence is not found, utilizing gradient descent of the quasi-likelihood to generate next hyperparameters and repeating operations ii-vi;
vii. when convergence is found, estimating a final posterior mode;
viii. estimating a mean function and a covariance kernel for the final posterior mode; and
ix. drawing samples from distribution as samples from the final posterior mode.

8. A system comprising:
a memory comprising instructions; and
one or more computer processors, wherein the instructions, when executed by the one or more computer processors, cause the one or more computer processors to perform operations comprising:
a. identifying utilities to be maximized when presenting user feeds to users of a social network, each utility being associated with a respective weight for mixing items when creating the user feeds;
b. identifying a maximization goal for the utilities such that a first utility is maximized while other utilities are above a respective predetermined threshold;
c. initializing a counter to zero;
d. generating sample weights;
e. performing an experiment with the generated sample weights for a plurality of users and a plurality of user feed sessions to determine a utility action indicator for each of the utilities for each pair of user and job;
f for each utility, estimating a posterior distribution of an underlying hyperfunction and drawing sample hyperfunctions;
g. for each drawn sample, calculating a utility function and calculating the weight from the sample weights that maximizes the calculated utility function;
h. generating an empirical distribution based on the calculated weights;
i. until the calculated weights converge, incrementing the counter and repeating operations d-i; and
j. utilizing the identified calculated weights after the convergence for mixing the items when creating the user feeds.

9. The system as recited in claim 8, wherein mixing the items when creating the user feeds further comprises:
identifying a pool of candidates for each utility, each candidate having a candidate score;
multiplying each candidate score by the corresponding weight; and
mixing the candidates to create the user feed based on a result of the multiplying.

10. The system as recited in claim 9, wherein performing the experiment further comprises:
creating the user feeds utilizing the sample weights for mixing the candidates.

11. The system as recited in claim 8, wherein the utility action indicator for each of the utilities for each pair of user and job is determined by assigning a value of 1 when the experiment indicates that the user acted on the utility during the user feed session and assigning a value of 0 when the user did not act on the utility during the user feed session.

12. The system as recited in claim 8, wherein the utilities comprise one or more of user posts, job posts, and sponsored posts.

13. The system as recited in claim 8, wherein the utility function is calculated with based on a smoothing function of the sample hyperfunctions.

14. The system as recited in claim 8, wherein estimating the posterior distribution further comprises:
i. choosing initial values for hyperparameters;
ii. evaluating a covariance kernel based on the hyperparameters;
iii. generating a posterior mode;
iv. computing a quasi-loglikelihood;
v. checking for convergence;
vi. when convergence is not found, utilizing gradient descent of the quasi-likelihood to generate next hyperparameters and repeating operations ii-vi;
vii. when convergence is found, estimating a final posterior mode;
viii. estimating a mean function and a covariance kernel for the final posterior mode; and
ix. drawing samples from distribution as samples from the final posterior mode.

15. A non-transitory machine-readable storage medium including instructions that, when executed by a machine, cause the machine to perform operations comprising:
a. identifying utilities to be maximized when presenting user feeds to users of a social network, each utility being associated with a respective weight for mixing items when creating the user feeds;
b. identifying a maximization goal for the utilities such that a first utility is maximized while other utilities are above a respective predetermined threshold;
c. initializing a counter to zero;
d. generating sample weights;
e. performing an experiment with the generated sample weights for a plurality of users and a plurality of user feed sessions to determine a utility action indicator for each of the utilities for each pair of user and job;
f. for each utility, estimating a posterior distribution of an underlying hyperfunction and drawing sample hyperfunctions;
g. for each drawn sample, calculating a utility function and calculating the weight from the sample weights that maximizes the calculated utility function;
h. generating an empirical distribution based on the calculated weights;
i. until the calculated weights converge, incrementing the counter and repeating operations d-i; and
j. utilizing the identified calculated weights after the convergence for mixing the items when creating the user feeds.

16. The machine-readable storage medium as recited in claim 15, wherein mixing the items when creating the user feeds further comprises:
identifying a pool of candidates for each utility, each candidate having a candidate score;
multiplying each candidate score by the corresponding weight; and
mixing the candidates to create the user feed based on a result of the multiplying.

17. The machine-readable storage medium as recited in claim 16, wherein performing the experiment further comprises:
creating the user feeds utilizing the sample weights for mixing the candidates.

18. The machine-readable storage medium as recited in claim 15, wherein the utility action indicator for each of the utilities for each pair of user and job is determined by assigning a value of 1 when the experiment indicates that the user acted on the utility during the user feed session and assigning a value of 0 when the user did not act on the utility during the user feed session.

19. The machine-readable storage medium as recited in claim 15, wherein the utilities comprise one or more of user posts, job posts, and sponsored posts.

20. The machine-readable storage medium as recited in claim 15, wherein the utility function is calculated with based on a smoothing function of the sample hyperfunctions.
